(19) United States
(12) Patent Application Publication
(10) Pub. No.: US 2025/0199987 A1
(43) Pub. Date: Jun. 19, 2025

(54) BIDIRECTIONAL HIGH-SPEED INTERFACES AGGREGATOR

(71) Applicant: QUALCOMM Incorporated, San Diego, CA (US)

(72) Inventors: Shruti HANUMANTHAIAH, Bangalore (IN); Sanjukta DAS, Visakhapatnam (IN)

(21) Appl. No.: 18/539,185

(22) Filed: Dec. 13, 2023

(51) Int. Cl. G06F 13/42

(52) U.S. Cl. CPC G06F 13/4221

(57) ABSTRACT

Aspects of the disclosure are directed to bidirectional high-speed interfaces. In accordance with one aspect, disclosed is an apparatus including an aggregator configured to aggregate a plurality of signals to form an aggregated signal; a common transmission path coupled to the aggregator, the common transmission path configured to transport the aggregated signal, wherein the common transmission path includes a mechanical discontinuity; and a deaggregator coupled to the common transmission path, the deaggregator configured to decompose the aggregated signal into one or more constituent signals.

### TECHNICAL FIELD

This disclosure relates generally to the field of information processing systems, and, in particular, to bidirectional high-speed interfaces between a processor and a plurality of peripheral devices.

### BACKGROUND

Information processing systems may include multiple processing engines, processors or processing cores for a variety of user applications. An information processing system may include a central processing unit (CPU), a graphics processing unit (GPU), a digital signal processor (DSP), an image signal processor (ISP), a neural processing unit (NPU), etc., along with input/output interfaces, a hierarchy of memory units and associated interconnection databuses. In addition, the information processing system may include a plurality of peripheral devices which communicate with a processing engine using a plurality of high-speed interfaces. In certain scenarios, the plurality of high-speed interfaces may result in a large quantity of transmission media paths to implement the plurality of high-speed interfaces. Therefore, to minimize overall product form factor, a bidirectional high-speed interface with aggregation may be employed to achieve a smaller form factor packaging solution for processor-peripheral device communications.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides bidirectional high-speed interfaces. Accordingly, an apparatus including an aggregator configured to aggregate a plurality of signals to form an aggregated signal; a common transmission path coupled to the aggregator, the common transmission path configured to transport the aggregated signal, wherein the common transmission path includes a mechanical discontinuity; and a deaggregator coupled to the common transmission path, the deaggregator configured to decompose the aggregated signal into one or more constituent signals.

In one example, the apparatus further includes a processor coupled to the aggregator. In one example, the aggregator is further configured to receive a plurality of signals in proximity to the processor. In one example, the plurality of signals originates from a plurality of peripheral devices. In one example, the plurality of peripheral devices includes one or more of the following: a camera, a display processor unit (DPU), an audio device, a serial engine (SE) information, or a first general purpose input output (GPIO) interface. In one example, the one or more constituent signals is the plurality of signals.

In one example, the aggregated signal includes a time stamp. In one example, the time stamp is a numeric representation of a local time at the processor. In one example, the numeric representation of local time includes a specified time accuracy and a specified time stability. In one example, the aggregated signal includes a plurality of incremental time stamps for each of the plurality of signals.

Another aspect of the disclosure provides a method including: aggregating a first plurality of signals to form an aggregated signal; transporting the aggregated signal over a common transmission path, wherein the common transmission path includes a mechanical discontinuity; and decomposing the aggregated signal into one or more constituent signals. In one example, the first plurality of signals originates from a plurality of peripheral devices.

In one example, the method further includes using a packet aggregation protocol for aggregating the first plurality of signals. In one example, the packet aggregation protocol is performed asynchronously. In one example, the packet aggregation protocol is performed synchronously. In one example, the aggregated signal includes a time stamp. In one example, the time stamp is a numeric representation of a local time at a processor.

In one example, the method further includes receiving the aggregated signal from the common transmission path in proximity to a first processor. In one example, the method further includes receiving one or more control signals from the common transmission path. In one example, the method further includes receiving the first plurality of signals in proximity to a second processor. In one example, the method further includes sending the one or more constituent signals to a plurality of output devices. In one example, the one or more constituent signals is the first plurality of signals.

In one example, the method further includes sending a second plurality of signals from the first processor over the common transmission path. In one example, the method further includes receiving the second plurality of signals at a second processor and relaying the second plurality of signals to the plurality of peripheral devices.

Another aspect of the disclosure provides an apparatus for bidirectional high-speed interfaces, the apparatus including: means for aggregating a plurality of signals to form an aggregated signal; means for transporting the aggregated signal over a common transmission path, wherein the common transmission path includes a mechanical discontinuity; and means for decomposing the aggregated signal into one or more constituent signals.

In one example, the apparatus further includes: means for receiving the aggregated signal from the common transmission path in proximity to a first processor; means for receiving the plurality of signals in proximity to a second processor; and means for sending the one or more constituent signals to a plurality of output devices.

In one example, the aggregated signal includes a time stamp and wherein the time stamp is a numeric representation of a local time at the second processor, and the numeric representation of local time includes a specified time accuracy and a specified time stability. In one example, the aggregated signal includes a plurality of incremental time stamps for each of the plurality of signals.

Another aspect of the disclosure provides a non-transitory computer-readable medium storing computer executable code, operable on a device including at least one processor and at least one memory coupled to the at least one processor, wherein the at least one processor is configured to implement bidirectional high-speed interfaces, the computer executable code including: instructions for causing a computer to aggregate a plurality of signals to form an aggregated signal; instructions for causing the computer to transport the aggregated signal over a common transmission path, wherein the common transmission path includes a mechanical discontinuity; and instructions for causing the computer to decompose the aggregated signal into one or more constituent signals.

In one example, the non-transitory computer-readable medium further includes: instructions for causing the computer to receive the aggregated signal from the common transmission path in proximity to a first processor; instructions for causing the computer to receive the plurality of signals in proximity to a second processor, wherein the aggregated signal includes a time stamp and wherein the time stamp is a numeric representation of a local time at the second processor, and the numeric representation of local time includes a specified time accuracy and a specified time stability; and instructions for causing the computer to send the one or more constituent signals to a plurality of output devices.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example of a smart glasses design.

FIG. 3 illustrates an example of a design challenge area for a smart glasses design.

FIG. 4 illustrates an example timeline graph for inbound and outbound data traffic in an information processing system.

FIG. 5 illustrates an example of a compact information processing system.

FIG. 6 illustrates an example of a detailed depiction of aggregation and de-aggregation for the compact information processing system.

FIG. 7 illustrates a first example of an aggregator integration with a processor die.

FIG. 8 illustrates a second example of an aggregator integration with a processor die.

FIG. 9 illustrates a third example of an aggregator integration with a processor die.

FIG. 10 illustrates an example flow diagram for bidirectional high-speed data transport between a processor and a plurality of peripheral devices.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), may require multiple levels of coordination or synchronization. In one example, a slice may include a processing engine (i.e., a subset of the computing system) as well as associated memory units and other peripheral devices. In one example, execution of an application may be decomposed into a plurality of work tasks which are executed by multiple slices or multiple processing engines.

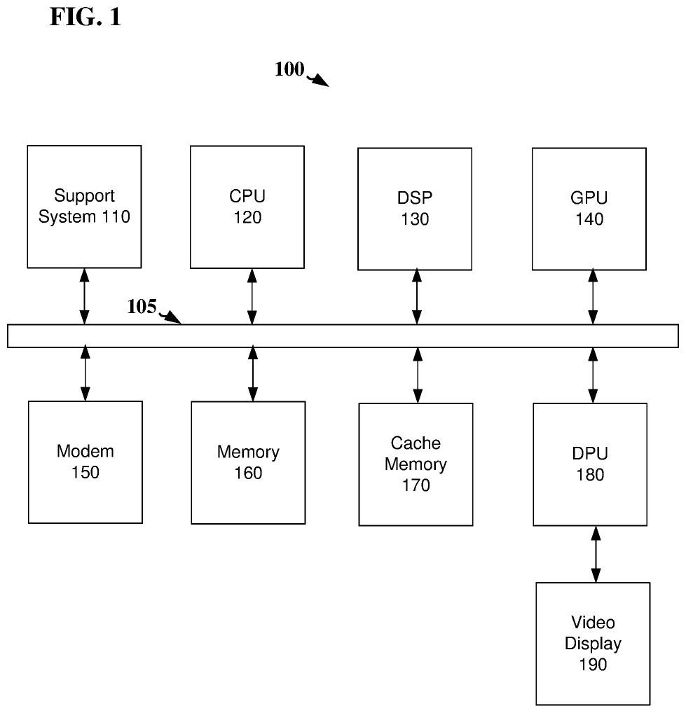

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information.

For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, one or more processing engines in the information processing system 100 may connect to a plurality of peripheral devices to provide additional functionality. The plurality of peripheral devices may include, for example, cameras, imagers, sensors, displays, speakers, microphones, etc. In one example, processor-peripheral device communications may be implemented by a bidirectional high-speed interface.

In one example, the information processing system 100 may be part of a wireless device in a wireless communication system. For example, the wireless communication system may conform to a wireless network protocol such as 4G LTE (long term evolution), 5G NR (new radio, etc.

In one example, a design for a small form factor device with multiple peripheral interfaces may be compromised by a large quantity of transmission media paths to implement the plurality of high-speed interfaces. For example, small form factor devices such as extended reality (XR) devices, augmented reality (AR) viewers, smart glasses, wearable devices, etc. may have a large quantity of interfaces which increases with successive design generations. For example, small form factor devices may require high-speed interfaces with cameras, high resolution video displays with a large number of data transport lanes and side bands, digital microphones (DMICs), audio speakers, etc. For example, a standalone system on a chip (SOC) may have size and resource constraints to accommodate a necessary quantity of circuitry (e.g., chip intellectual property (IP) which causes die expansion. For example, the standalone SOC may have size and resource constraints to accommodate a necessary quantity of circuit balls and signal count which causes package expansion. For example, the standalone SOC may have size and resource constraints to accommodate a size constraint due to a limited printed circuit board (PCB) area.

In one example, a design for a small form factor device with multiple peripheral interfaces may have signal routing constraints due to a plurality of PCBs in the device. For example, peripheral devices may be distributed (e.g., not uniformly) over the device form factor. For example, the device may have a plurality of PCBs and narrow hinges. For example, signal routing multiple high-speed signals across the hinges over flexible transmission lines (e.g., cables) may lead to signal attenuation and signal integrity issues. For example, there may be a design restriction on the quantity of signals which may be routed over the hinges if the form factor is required to be sleek (e.g., low profile). For example, a split PCB design approach may be considered in XR and Internet of Things (IoT) platforms to case PCB placement issues.

In one example, usage of a single SOC may encounter thermal and de power issues. For example, usage of a single SOC for handling all peripheral devices and their processing may result in a device temperature which exceeds an acceptable temperature threshold. For example, a device which is worn by a person may have constraints on maximum skin temperature. For example, dc power distribution across PCBs and SOCs may be a significant design driver in this single SOC scenario.

In one example, as a small form factor device includes a lower node voltage level design, an increase in a engineering bill of materials (eBOM) may result. In one example, a quantity of voltage level translators, which translate from a first node voltage level to a second node voltage level, may increase as successive design generations of SOCs transition to a lower node voltage level design. For example, the SOC may operate at a lower voltage level than the peripheral devices which may result in a higher eBOM cost and larger PCB area due to an increased need for voltage level translators.

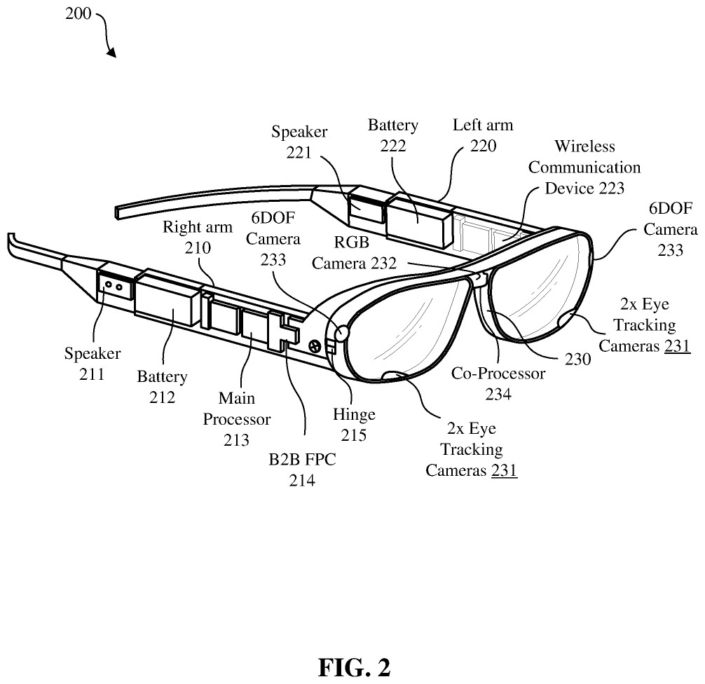

In one example, one small form factor device is smart glasses, a compact implementation of an information processing system. FIG. 2 illustrates an example of a smart glasses design 200. In one example, the smart glasses design 200 includes a right arm 210, a left arm 220 and a nose section 230. In one example, the right arm 210 includes a first speaker 211, a first battery 212, a main processor 213, a flexible connector 214 (e.g., B2B connector, FPC connector) and a hinge 215. In one example, the left arm 220 includes a second speaker 221, a second battery 222, a wireless communication device 223 (e.g., WiFi modem). In one example, the nose section 230 includes a pair of eye tracking cameras 231, a red green blue (RGB) camera 232, two six degree of freedom (6DOF) camera 233, and a co-processor 234.

In one example, the main processor 213 is an augmented reality (AR) computing platform. In one example, the main processor 213 includes a plurality of PCBs: a first PCB (not shown) on the right arm 210, a second PCB (not shown) on the left arm 220 and a third PCB (not shown) on a nose bridge of the nose section 230. In one example, the first PCB hosts the main processor 213, the second PCB hosts the wireless communication device 223 and the third PCB hosts the co-processor 234. In one example, signal routing across hinges in the smart glasses design 200 is a design factor for small form factor devices.

In one example, the co-processor 234 multiplexes a plurality of peripheral device signals (e.g., signals from cameras, sensors, etc.) with multiple wires crossing hinges and nose bridge which may result in bulky connectors and a large form factor. In one example, the main processor disclosed in FIG. 2 is an application processor.

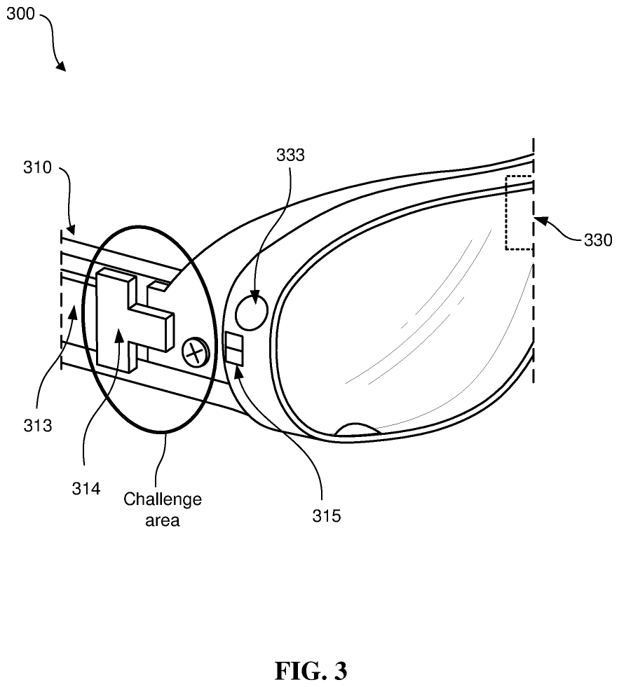

FIG. 3 illustrates an example 300 of a design challenge area for a smart glasses design. Illustrated in FIG. 3, for example, is a right arm portion 310 and a nose section portion 330. In one example, the right arm portion 310 includes a main processor 313 (not shown), a flexible connector 314 (e.g., B2B connector, FPC connector) and a hinge 315. In one example, the nose section portion 330 includes a 6DOF camera 333. In one example, design of the interface between the right arm portion 310 and the nose section portion 330 may present challenges due to a small PCB area, a limited quantity of wires across the hinge 315 and a power/thermal constraint on maximum operational dc power and maximum standby dc power. For example, the limited quantity of wires may accommodate no more than 40 high-speed signals and 40 low-speed signals for the main processor 313. For example, the maximum operational dc power may be 1000 mW and the maximum standby dc power may be 10 mW. In one example, the hinge 315 represents a mechanical discontinuity over a common transmission path. In one example, a design constraint is minimizing the quantity of wires and connectors at the mechanical discontinuity (e.g., the hinge 315) to allow a smaller form factor in the smart glasses design.

In one example, a bidirectional high-speed interface between a processor and a plurality of peripheral devices may use an aggregator and a de-aggregator to achieve a smaller form factor packaging solution for processor-peripheral device communications. In one example, the aggregator combines or multiplexes high-speed, real-time data signals (e.g., peripheral device signals) which may convey data between a processor and a plurality of peripheral devices into an aggregated data signal over an aggregated transmission path. In one example, the de-aggregator decomposes or demultiplexes high-speed, real-time data signals (e.g., peripheral device signals) from the aggregated data signal over the aggregated transmission path.

In one example, the aggregated transmission path may include a plurality of data lanes, wherein each data lane has a lane data rate. In one example, the aggregate data rate of the aggregated transmission path is a sum of lane data rates for the plurality of data lanes. For example, each data lane may be a constituent of the aggregated transmission path.

In one example, outbound signals, i.e., from the processor to the plurality of peripheral devices, may include a display signal which conforms to a display serial interface (DSI) protocol, an audio signal which conforms to a Sound Wire (SWR) protocol, or an inter-integrated circuit sound (I2S) protocol, etc. In one example, inbound signals, i.e., from the plurality of peripheral devices to the processor, may include a camera signal which conforms to a camera serial interface (CSI) protocol, a sensor signal which conforms to a serial peripheral interface (SPI) protocol, an inter-integrated circuit (I2C) protocol, an improved inter-integrated circuit (I3C) protocol, or a digital microphone (DMIC) signal, etc. In one example, the aggregator and de-aggregator combine high-speed, real-time data signals in both directions (i.e., bidirectionally), i.e., outbound signals and inbound signals.

In one example, the aggregator may be situated in proximity to the processor within a processor PCB. In one example, the aggregator may arbitrate the combining and synchronization of the high-speed, real-time data signals and maintains a quality of service (QOS) level in transmission of data. In one example, the de-aggregator may be situated in proximity to the plurality of peripheral devices within a peripheral PCB. In one example, the de-aggregator may arbitrate the decomposition and synchronization of the high-speed, real-time data signals, and maintains a quality of service (QOS) level in transmission of data.

In one example, the aggregator circuitry (e.g., chip IP) may be part of the processor die or may be part of a chiplet (i.e., subsection of a chip) configuration along with the processor die. In one example, the aggregator circuitry may be part of a separate package which interfaces to the plurality of peripheral devices via a high data rate chip-chip communications interface, for example, a network on a chip (NOC).

In one example, the high data rate chip-chip communications interface is a high-speed, real-time bidirectional (e.g., full duplex) interface between the aggregator and the de-aggregator. For example, the interface may enable bidirectional data transmission in real time, that is, within specified timeline constraints or with low latency (i.e., time delay). For example, the interface may be memory mapped using PCIe (peripheral component interconnect-express), USB (universal serial bus), M-PHY (mobile physical layer interface), a chip-chip interface, etc.

In one example, data being transported across an aggregated transmission path may require time messaging from a source to a destination over the aggregated transmission path. For example, video display data being transported from the source to the destination may be conveyed on a line-by-line basis, wherein a line is one horizontal display component of the video display data. For example, each line may require a separate time message.

In one example, the time messaging may be part of a data transmission protocol for the aggregated transmission path. In one example, the time messaging may be implemented using a time stamp or a time tag. For example, the time stamp or time tag may be a numeric representation of local time at the source. For example, the time stamp may be regenerated at the destination. For example, regeneration of the time stamp may include calibration of a time delay between the source and the destination. In one example, some interface protocols (e.g., PCIe) may interleave the time stamp with other data. In one example, inbound data (e.g., from cameras or sensors) may be sent simultaneously in parallel to the display and with other data.

For example, the numeric representation of local time may have a specified time accuracy and a specified time stability. For example, specified time accuracy may refer to an upper bound on local time difference relative to an absolute time reference (e.g., UTC). For example, the local time may be obtained from a local global positioning system (GPS) receiver or from a computer network time server using, for example, network time protocol (NTP) or precision time protocol (PTP). For example, specified time stability may refer to an upper bound on relative changes in local time error over different time scales or different environmental conditions.

In one example, data being transported across an aggregated transmission path may require other low-rate data from the source to the destination over the aggregated transmission path. For example, the other low-rate data may include Sound Wire (SWR) data which may be interleaved with other data on one data lane or may be transported on separate data lanes.

In one example, the time messaging and other low-rate data may be transported over a different peripheral interface, for example, I3C or UART (universal asynchronous receiver transmitter). In one example, the main processor disclosed in FIG. 3 is an application processor

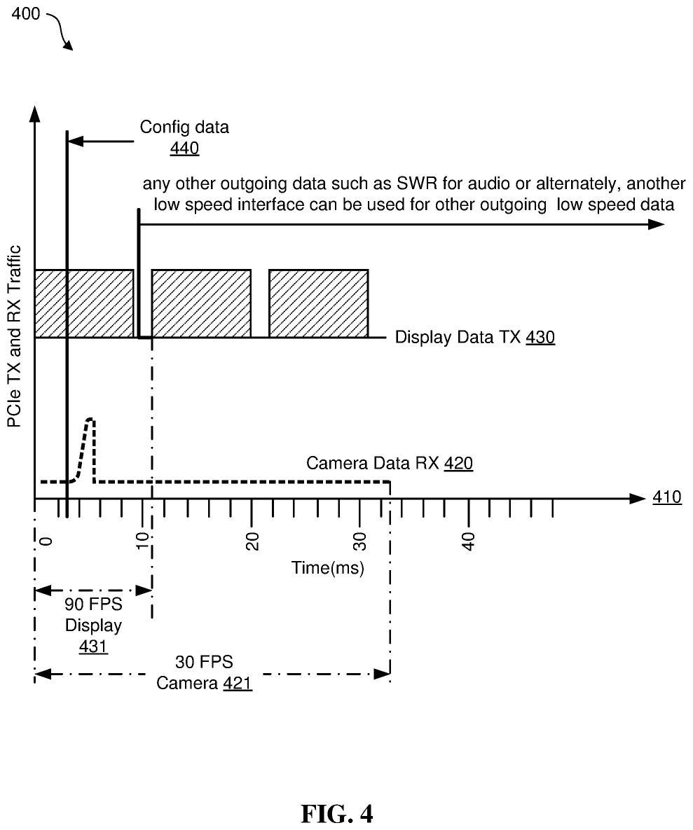

FIG. 4 illustrates an example timeline graph 400 for inbound and outbound data traffic in an information processing system. For example, shown is a timeline 410, denoted in units of milliseconds (ms). For example, camera data receive (RX) 420 is transported at a 30 frame per second (fps) rate 421. For example, display data transmit (TX) 430 is transported at a 90 fps rate 431. For example, configuration data 440 is transported, as required, during the timeline 410. For example, other outgoing data, such as SWR for audio or another low-speed data may be transported during the timeline 410.

In one example real-time bidirectional data (e.g., display and camera data) may be transported simultaneously over a full duplex interface (e.g., PCIe). In one example, further optimization to transport display data in batches to optimize link dc power utilization and to interleave other outbound data may be performed as well.

In one example, a high-speed interface between a processor and a plurality of peripheral devices may be unidirectional, for example, only aggregation of inbound signals (e.g., camera signal, sensor signal, microphone signal, etc.) is performed and outbound signals are not aggregated. In one example, a high-speed interface between a processor and a plurality of peripheral devices may be bidirectional, for example, with aggregation of both inbound signals and outbound signals (e.g., display signals in a DSI format, audio signals in a SWR, I2R format and with codec overhead, etc.). For example, the bidirectional high-speed interface may by a full duplex communications interface. For example, full duplex may refer to bidirectional, simultaneous communications between two entities. For example, half duplex may refer to bidirectional, sequential communications between two entities.

In one example, the aggregator is part of a main processor subsystem and may be a separate chip die in a chiplet configuration or may be a separate package in the main processor subsystem. For example, usage of the aggregator and de-aggregator in an application may be selected if the application includes a high quantity (e.g., much greater than 10) of peripheral interfaces and features (e.g., an augmented reality (AR) viewer). For example, usage of the aggregator and de-aggregator in an application may not be selected if the application includes a low quantity (e.g., less than 10) of peripheral interfaces and features. In one example, the main processor subsystem is an application processor subsystem.

In one example, the aggregator and de-aggregator may also integrate with non-real-time signals such as recorded audio and other serial data interfaces. In one example, the aggregator may multiplex (i.e., combine) various data and control interfaces which correspond to various functions such as display, camera, audio, memory, storage controls, sensors, etc. In one example, the de-aggregator may demultiplex (i.e., decomposes) various data and control interfaces.

In one example, there may be a separate low-speed interface between the aggregator and de-aggregator for low data rate signals and control signals. In one example, the separate low-speed interface (e.g., I3C, SPI) may be operational in a low power or standby power mode, while the high-speed interface is not operational, thus saving dc power consumption.

In one example, there also may be sideband handshake signals between the aggregator and de-aggregator. For example, sideband refers to an auxiliary channel separate from the main communications channel. For example, handshake signals refer to signals used for initialization and coordination between two entities to facilitate data transport.

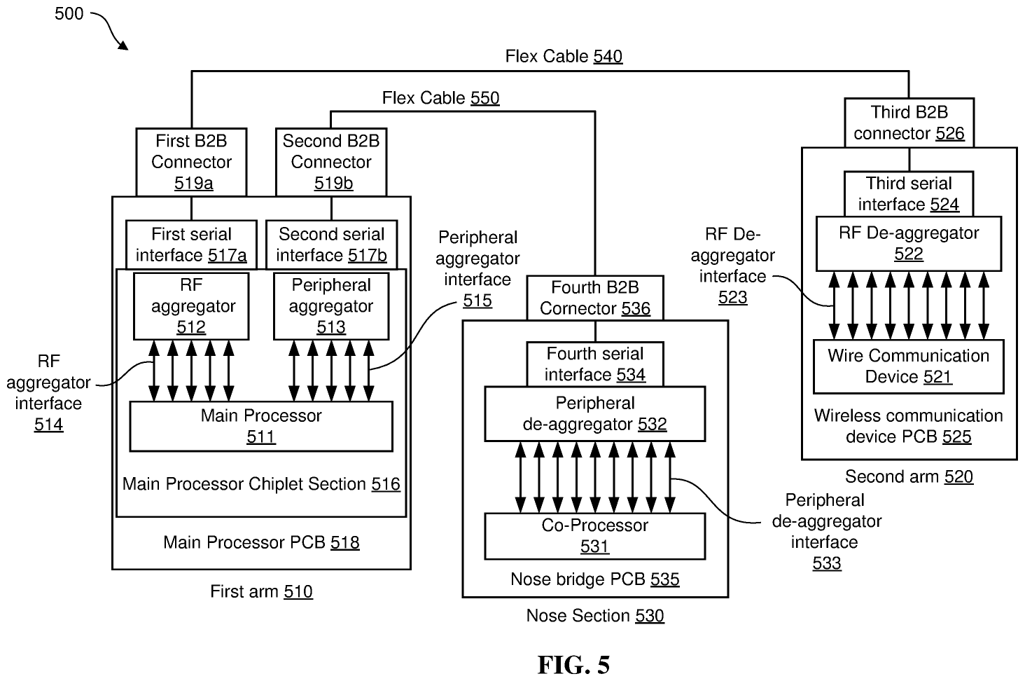

FIG. 5 illustrates an example of a compact information processing system (e.g., smart glasses) 500. In one example, the compact information processing system 500 includes a right arm 510 (e.g., first arm), a left arm 520 (e.g., second arm) and a nose section 530.

In one example, the right arm 510 includes a main processor 511 (e.g., a system on a chip (SOC)), a radio frequency (RF) aggregator 512, a peripheral aggregator 513, a RF aggregator interface 514, a peripheral aggregator interface 515, a main processor chiplet section 516, a first serial interface 517a, a second serial interface 517b, a main processor PCB 518, a first board-to-board (B2B) connector 519a and a second B2B connector 519b. In one example, the RF aggregator 512 multiplexes data signals (e.g., wireless communication and networking signals, audio signals, etc.) for the left arm 520. In one example, the peripheral aggregator 513 multiplexes data signals (e.g., camera signals, sensor signals, display signals, etc.) for the nose section 530. In one example, the main processor disclosed in FIG. 5 is an application processor.

In one example, the left arm 520 includes a wireless communication device 521 (e.g., WiFi modem), a RF de-aggregator 522, a RF de-aggregator interface 523, a third serial interface 524, a wireless communication device PCB 525 (e.g., connectivity island) and a third B2B connector 526.

In one example, the nose section 530 includes a co-processor 531, a peripheral de-aggregator 532, a peripheral de-aggregator interface 533, a fourth serial interface 534, a nose bridge PCB 535, and a fourth B2B connector 536.

In one example, the right arm 510 and the left arm 520 may be interconnected via a first flexible cable 540 using the first B2B connector 519a and the third B2B connector 526. In one example, the right arm 510 and the nose section 530 may be interconnected via a second flexible cable 550 using the second B2B connector 519b and the fourth B2B connector 536.

In one example, some signals which cannot be aggregated, that is, non-aggregated signals, may still be processed by the RF aggregator 512 and the peripheral aggregator 513 for voltage level shifting with a one-to-one mapping. That is, the non-aggregated signals may have their voltage level transformed from an input voltage level to an output voltage level using voltage level shifting. In one example, the non-aggregated signals are bidirectional.

In one example, the RF de-aggregator 522 and the peripheral de-aggregator 532 are situated adjacent to peripheral devices. In one example, the RF de-aggregator 522 and the peripheral de-aggregator 532 receive aggregated data signals from the RF aggregator 512 and the peripheral aggregator 513 and demultiplex the aggregated data signals to individual signal for the peripheral devices.

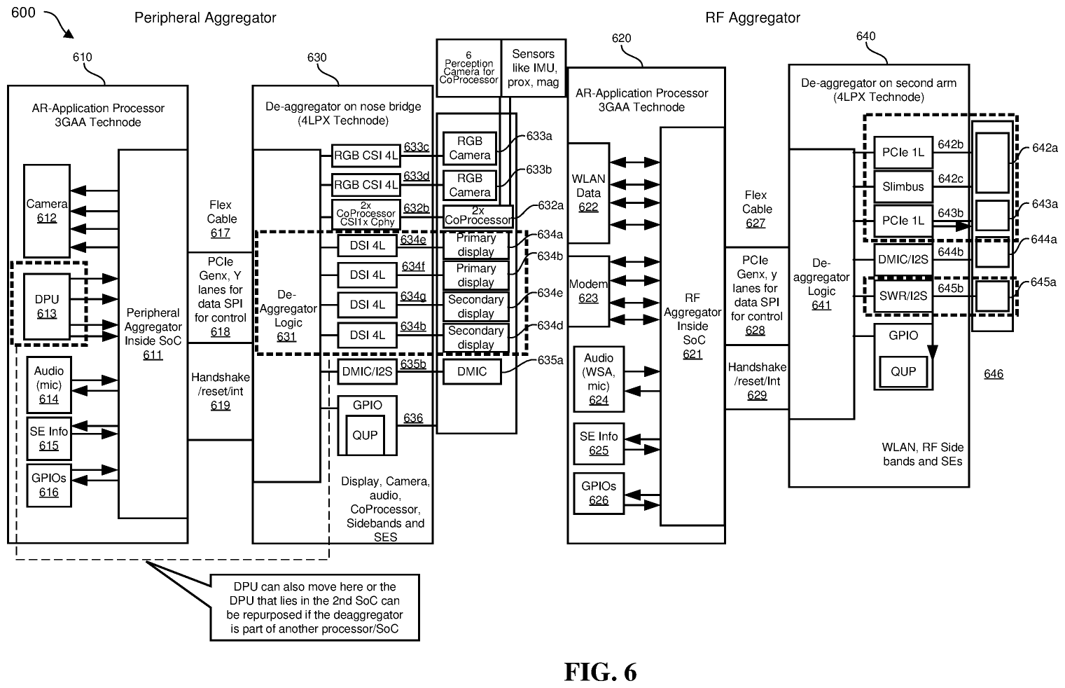

FIG. 6 illustrates an example of a detailed depiction of aggregation and de-aggregation 600 for the compact information processing system. In one example, a first main processor 610 includes a peripheral aggregator 611 and a first plurality of peripheral devices such as a camera 612, a display processor unit (DPU) 613, a first audio device 614 (e.g., microphone), a first serial engine (SE) information 615, a first general purpose input output (GPIO) interface 616, etc. In one example, the peripheral aggregator 611 multiplexes data signals from the first plurality of peripheral devices to form a first aggregated data signal 617 which may be sent over a first flexible cable.

In one example, a first de-aggregator 630 includes a first de-aggregator logic circuitry 631, a plurality of co-processor interfaces 632b, a plurality of RGB camera interfaces 633c, 633d, a plurality of display device interfaces 634c, 634f, 634g, 634h, a first digital microphone (DMIC) interface 635b, a second GPIO interface 636, etc. For example, the DPU 613 may be situated with the first de-aggregator 630 instead of with the first main processor 610. Alternatively, if there is no first de-aggregator 630, the DPU 613 may be repurposed towards another function.

In one example, the plurality of co-processor interfaces 632b conforms to a camera serial interface (CSI) protocol (e.g., in a C-PHY mode of the CSI protocol) and connects with a co-processor 632a. In one example, the co-processor 632a is connected to other sensors such as an inertial measurement unit (IMU), proximity sensor, magnetometer, accelerometer, etc.

In one example, the plurality of RGB camera interfaces 633c, 633d conforms to the CSI protocol (e.g., in a four lane (4L) mode of the CSI protocol) and connects with a plurality of RGB cameras 633a, 633b. In one example, the plurality of display device interfaces 634c, 634f, 634g, 634h conforms to a display serial interface (DSI) protocol (e.g., in a 4L or one lane (1L) mode of the DSI protocol) and connects with a plurality of display devices 634a, 634b, 634c, 634d. In one example, the first DMIC interface 635b conforms to the inter-integrated circuit sound (I2S) protocol and connects with a digital microphone (DMIC) 635a.

In one example, the first aggregated data signal 617 is sent over the first flexible cable from the first main processor 610 to the first de-aggregator 630. For example, the first aggregated data signal 617 may conform to a protocol such as PCIe, USB4, chip-chip interface, etc.

In one example, a first serial signal 618 connects the first main processor 610 with the first de-aggregator 630. For example, the first serial signal 618 may conform to a protocol such as SPI, I3C, etc. For example, the first serial signal 618 is used for control signaling.

In one example, a first handshake signal 619 (e.g., reset signal, initialization signal) connects the first main processor 610 with the first de-aggregator 630. For example, the first handshake signal 619 may be used for initialization and coordination between two entities to facilitate data transport.

In one example, the first de-aggregator logic circuitry 631 receives the first aggregated data signal 617 from the first main processor 610. In one example, the first de-aggregator logic circuitry 631 demultiplexes or decomposes the first aggregated data signal 617 to retrieve high-speed, real-time data signals (e.g., peripheral device signals) from the first aggregated data signal 617.

In one example, the first aggregated data signal 617 may include a first time stamp as a numeric representation of a first local time at the first main processor 610. For example, the first local time may be obtained from a local GPS receiver or from a computer network time server using, for example, NTP or PTP. For example, the numeric representation of local time may have a specified time accuracy and a specified time stability. For example, the first time stamp may be regenerated at the first de-aggregator 630. For example, regeneration of the first time stamp may include time delay calibration between the first main processor 610 and the first de-aggregator 630.

In one example, the time delay may be due to data transmission latency (e.g., due to a finite electromagnetic propagation speed) over the first flexible cable from the first main processor 610 to the first de-aggregator 630. For example, the time delay calibration may introduce a time offset which is combined with the first time stamp to derive a first calibrated time stamp at the first de-aggregator 630. For example, the combination of the first time stamp and the time offset may be an addition of a first time stamp value and the time offset.

In one example, a second main processor 620 includes a RF aggregator 621 and a second plurality of peripheral devices such as a wireless local area network (WLAN) data interface 622, a modem 623, a second audio device 624 (e.g., microphone, wafer scale package smart amplifier (WSA)), a second serial engine (SE) information 625, a third general purpose input output (GPIO) interface 626, etc. In one example, the RF aggregator 621 multiplexes data signals from the second plurality of peripheral devices to form a second aggregated data signal 627 which is sent over a second flexible cable.

In one example, a second de-aggregator 640 includes a second de-aggregator logic circuitry 641, a plurality of wireless network interfaces 642b, 642c (e.g., wireless connectivity network (WCN)), a SnapDragon Radio (SDR) interface 643b, a second DMIC interface 644b, an audio interface 645b, a fourth GPIO interface 646, etc. For example, the DPU 613 may be situated with the first de-aggregator 630 instead of with the first main processor 610. Alternatively, if there is no first de-aggregator 630, the DPU 613 may be repurposed towards another function.

In one example, the plurality of wireless network interfaces 642b, 642c conforms to the PCIe protocol and a Slimbus protocol, and connects with a wireless network 642a. In one example, the SDR interface 643b conforms to the PCIe protocol and connects with a SnapDragon Radio (SDR) 643a. In one example, the second DMIC interface 644b conforms to the I2S protocol and connects with a second DMIC 644a. In one example, the audio interface 645b conforms to the SWR/I2S protocol and connects with a WSA device 645a.

In one example, the second aggregated data signal 627 is sent over the second flexible cable from the second main processor 620 to the second de-aggregator 640. For example, the second aggregated data signal 627 may conform to a protocol such as PCIe, USB4, chip-chip interface, etc.

In one example, a second serial signal 628 connects the second main processor 620 with the second de-aggregator 640. For example, the second serial signal 628 may conform to a protocol such as SPI, I3C, etc. For example, the second serial signal 628 is used for control signaling.

In one example, a second handshake signal 629 (e.g., reset signal, initialization signal) connects the second main processor 620 with the second de-aggregator 640. For example, the second handshake signal 629 may be used for initialization and coordination between two entities to facilitate data transport.

In one example, the second de-aggregator logic circuitry 641 receives the second aggregated data signal 627 from the second main processor 620. In one example, the second de-aggregator logic circuitry 641 demultiplexes or decomposes the second aggregated data signal 627 to retrieve high-speed, real-time data signals (e.g., peripheral device signals) from the second aggregated data signal 627.

In one example, the second aggregated data signal 627 may include a second time stamp as a numeric representation of a second local time at the second main processor 620. For example, the second local time may be obtained from a local GPS receiver or from a computer network time server using, for example, NTP or PTP. For example, the numeric representation of local time may have a specified time accuracy and a specified time stability. For example, the second time stamp may be regenerated at the second de-aggregator 640. For example, regeneration of the second time stamp may include time delay calibration between the second main processor 620 and the second de-aggregator 640.

In one example, the time delay may be due to data transmission latency (e.g., due to a finite electromagnetic propagation speed) over the second flexible cable from the second main processor 620 to the second de-aggregator 640. For example, the time delay calibration may introduce a time offset which is combined with the second time stamp to derive a second calibrated time stamp at the second de-aggregator 640. For example, the combination of the second time stamp and the time offset is an addition of a second time stamp value and the time offset. In one example, the main processors disclosed in FIG. 6 are application processors.

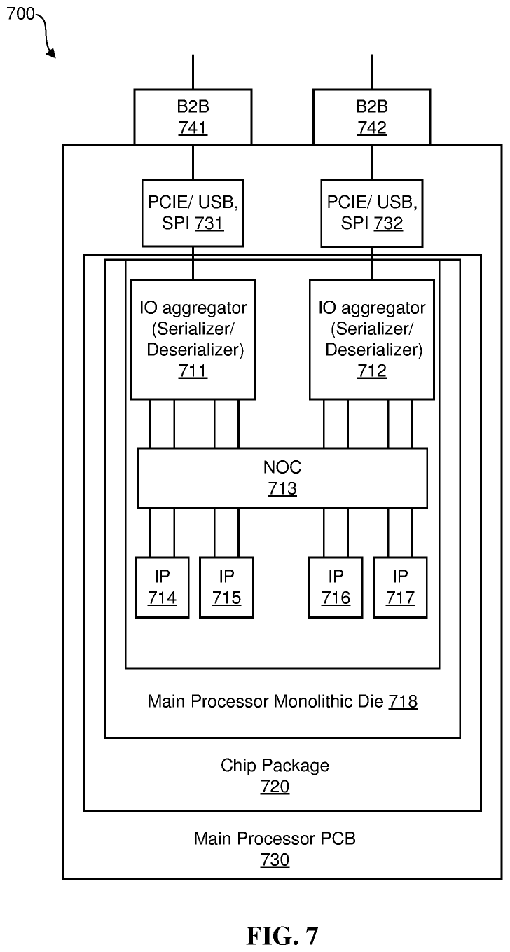

FIG. 7 illustrates a first example 700 of an aggregator integration with a processor die. In one example, a first aggregator 711 and a second aggregator 712 are integrated onto a main processor monolithic die 718 along with a NOC 713, a first IP module 714, a second IP module 715, a third IP module 716, a fourth IP module 717, etc. For example, the NOC 713 interconnects the first aggregator 711 and the second aggregator 712 with the IP modules 714, 715, 716, 717.

In one example, the main processor monolithic die 718 is placed onto a chip package 720. In one example, the chip package 720 is placed onto a main processor PCB 730, along with a first serial data interface 731 and a second serial data interface 732. In one example, the main processor PCB 730 includes a first B2B connector 741 and a second B2B connector 742. For example, the interconnection complexity of the NOC 713 is minimized due to the usage of a monolithic die for aggregator integration. In one example, the main processor disclosed in FIG. 7 is an application processor.

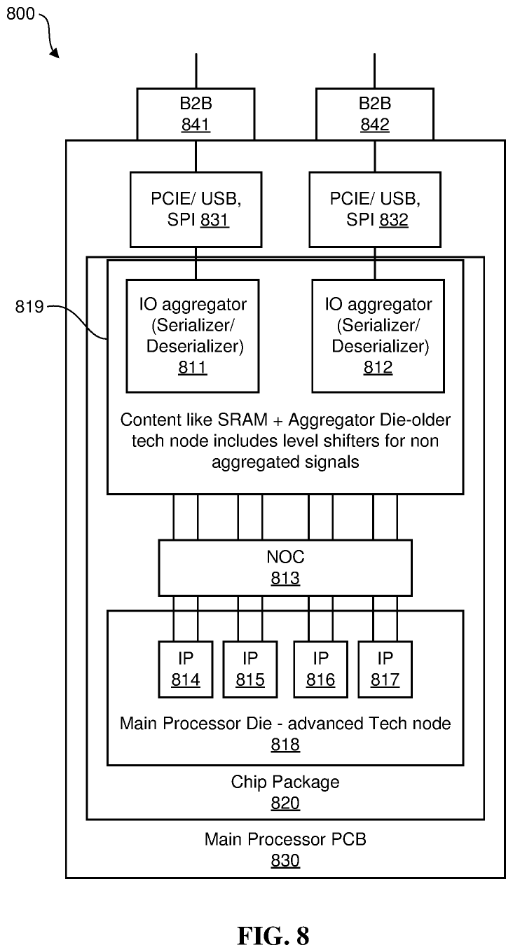

FIG. 8 illustrates a second example 800 of an aggregator integration with a processor die. In one example, a first aggregator 811 and a second aggregator 812 are integrated onto a separate aggregator die 819 (e.g., in a chiplet configuration). For example, the separate aggregator die 819 may be based on an older chip technology (i.e., older tech node). For example, the separate aggregator chip package 819 may also include voltage level shifters for non-aggregated signals.

In one example, a first IP module 814, a second IP module 815, a third IP module 816, a fourth IP module 817, etc. are integrated onto a main processor monolithic die 818. In one example, the main processor monolithic die 818, the separate aggregator die 819 and a NOC 813 are placed onto a chip package 820. In one example, the chip package 820 is placed onto a main processor PCB 830, along with a first serial data interface 831 and a second serial data interface 832. In one example, the main processor PCB 830 includes a first B2B connector 841 and a second B2B connector 842. For example, the main processor monolithic die 818 may be based on an advanced chip technology (i.e., advanced chip node).

For example, the separate aggregator die 819 may be integrated when the quantity of peripheral interfaces is high (e.g., much greater than 10). For example, the separate aggregator die 819 may be removed from the chip package 820 when the quantity of peripheral interfaces is low (e.g., less than 10). For example, usage of a separate aggregator die 819 (i.e., a chiplet configuration) may result in a spatially efficient design with a smaller required PCB area. In one example, the main processor disclosed in FIG. 8 is an application processor.

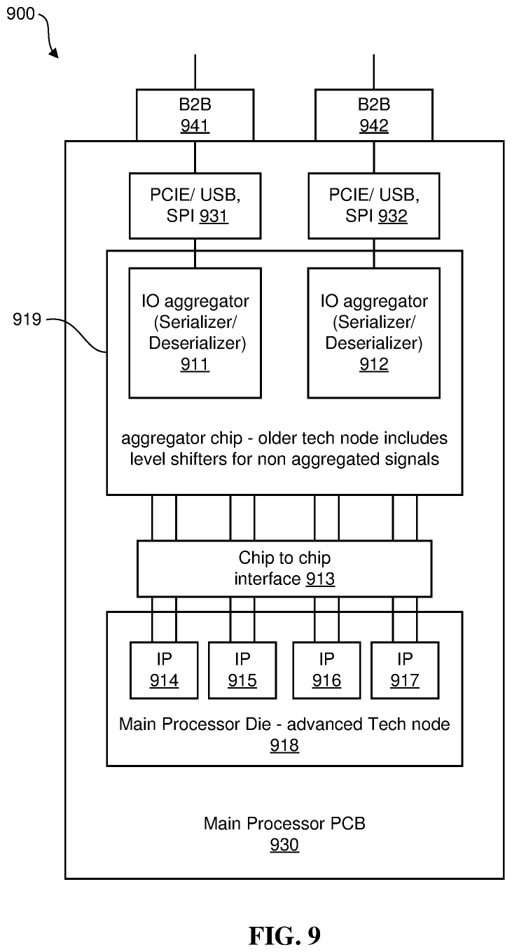

FIG. 9 illustrates a third example 900 of an aggregator integration with a processor die. In one example, a first aggregator 911 and a second aggregator 912 are integrated onto a separate aggregator chip package 919. For example, the separate aggregator chip package 919 may be based on an older chip technology (i.e., older tech node). For example, the separate aggregator chip package 919 may also include voltage level shifters for non-aggregated signals.

In one example, a first IP module 914, a second IP module 915, a third IP module 916, a fourth IP module 917, etc. are integrated onto a main processor chip package 918. In one example, the main processor chip package 918, the separate aggregator chip package 919 and a chip-chip interface module 913 are placed onto a main processor PCB 930, along with a first serial data interface 931 and a second serial data interface 932. In one example, the main processor PCB 930 includes a first B2B connector 941 and a second B2B connector 942. For example, the main processor chip package 918, may be based on an advanced chip technology (i.e., advanced chip node).

For example, the separate aggregator chip package 919 may be integrated when the quantity of peripheral interfaces is high (e.g., much greater than 10). For example, the separate aggregator chip package 919 may be removed from the main processor PCB 930 when the quantity of peripheral interfaces is low (e.g., less than 10). In one example, the main processor disclosed in FIG. 9 is an application processor.

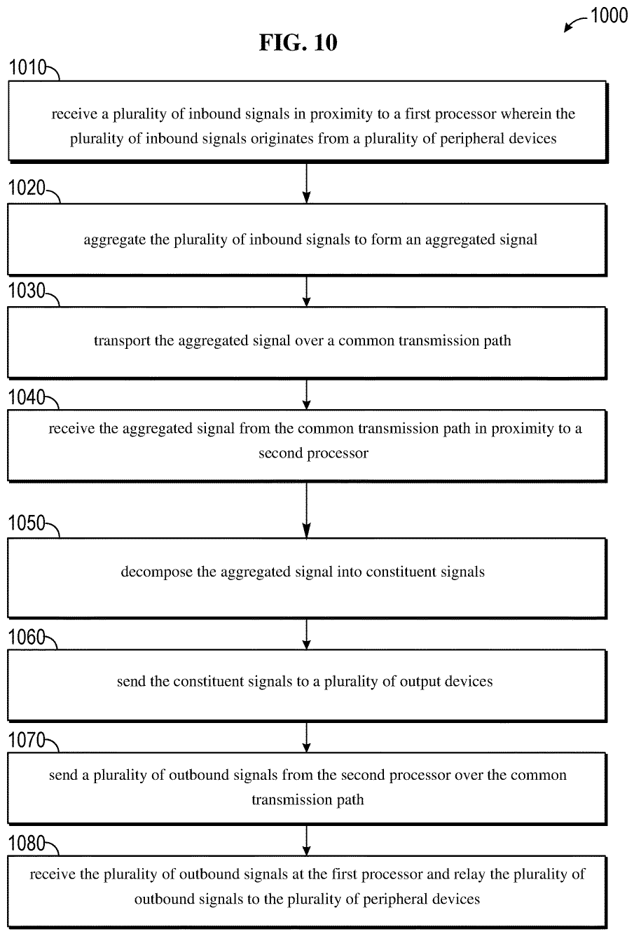

FIG. 10 illustrates an example flow diagram 1000 for bidirectional high-speed data transport between a processor and a plurality of peripheral devices. In block 1010, receive a plurality of inbound signals in proximity to a first processor (e.g., an application processor). That is, a plurality of inbound signals in proximity to a first processor (e.g., an application processor) is received. In one example, the plurality of inbound signals originates from a plurality of peripheral devices. In one example, the plurality of inbound signals are a plurality of packets. In one example, the plurality of inbound signals is received asynchronously (i.e., without a common time reference). In one example, the plurality of inbound signals is received synchronously (i.e., with a common time reference).

In one example, in proximity to a main processor means it is placed on a monolithic die where the main processor is integrated. In one example, in proximity to a main processor means it is placed on a separate die which is adjacent to a main processor die within a same chip package and which is interconnected using a network on a chip (NOC). In one example, in proximity to a main processor means it is placed on a separate chip package which is adjacent to a main processor chip package and which is interconnected using a chip-chip interface.

In block 1020, aggregate the plurality of inbound signals to form an aggregated signal. That is, the plurality of inbound signals is aggregated to form an aggregated signal. In one example, the aggregation is performed by an aggregator in proximity to the main processor. In one example, the aggregation is implemented using a packet aggregation protocol. In one example, the packet aggregation protocol is performed asynchronously (i.e., without a common time reference). In one example, the packet aggregation protocol is performed synchronously (i.e., with a common time reference). In one example, the aggregator may also perform voltage level shifting on nonaggregated signals.

In one example, the aggregated signal includes a time stamp. In one example, the time stamp is a numeric representation of a local time at the processor. For example, the local time may be obtained from a local GPS receiver or from a computer network time server using, for example, network time protocol (NTP) or precision time protocol (PTP). For example, the numeric representation of local time may have a specified time accuracy and a specified time stability.

In one example, the aggregated signal includes a plurality of incremental time stamps for each of the plurality of inbound signals. In one example, an individual time stamp for each of the plurality of inbound signals may be attained by combining the time stamp with each incremental time stamp of the plurality of incremental time stamps. In one example, an individual time stamp for each packet of the plurality of inbound signals may be attained by combining the time stamp with each incremental time stamp of the plurality of incremental time stamps.

In block 1030, transport the aggregated signal over a common transmission path. That is, the aggregated signal is transported over a common transmission path. In one example, the common transmission path includes a mechanical discontinuity (e.g., a hinge). In one example, the common transmission path is a type of flexible media. In one example, the type of flexible media is a flexible cable.

In block 1040, receive the aggregated signal from the common transmission path in proximity to a second processor. That is, the aggregated signal is received from the common transmission path in proximity to a second processor. In one example, the second processor is a co-processor. In one example, also receive control signals from the common transmission path. In one example, also receive handshake signals from the common transmission path.

In block 1050, decompose the aggregated signal into constituent signals. That is, the aggregated signal is decomposed into constituent signals. In one example, decomposition is performed by a de-aggregator. In one example, the constituent signals are the plurality of inbound signals. In one example, recover the time stamp from the aggregated signal. In one example, derive a calibrated time stamp by combining the recovered time stamp with a time offset. In one example, the time offset is derived from a time delay calibration between the processor and the de-aggregator. In one example, also receive non-aggregated signals which have been voltage level shifted.

In block 1060, send the constituent signals to a plurality of output devices. That is, the constituent signals is sent to a plurality of output devices. In one example, send the calibrated time stamp to the plurality of output devices. In one example, the calibrated time stamp may be used to maintain packet synchronization for real-time operations. In one example, the plurality of output devices includes a display device. In one example, the plurality of output devices includes the second processor.

In block 1070, send a plurality of outbound signals from the second processor over the common transmission path. That is, a plurality of outbound signals is sent from the second processor over the common transmission path. In one example, the common transmission path includes a mechanical discontinuity (e.g., a hinge). In one example, the plurality of outbound signals is aggregated before sending over the common transmission path. In one example, the aggregation is performed by an aggregator in proximity to the second processor. In one example, the aggregation is implemented using a packet aggregation protocol. In one example, the packet aggregation protocol is performed asynchronously (i.e., without a common time reference). In one example, the packet aggregation protocol is performed synchronously (i.e., with a common time reference).

In block 1080, receive the plurality of outbound signals at the first processor (e.g., application processor) and relay the plurality of outbound signals to the plurality of peripheral devices. That is, the plurality of outbound signals is received at the first processor (e.g., application processor), and the plurality of outbound signals is relayed to the plurality of peripheral devices. In one example, the plurality of outbound signals is decomposed into constituent signals after receiving from the common transmission path and before relaying to the plurality of peripheral devices. In one example, decomposition is performed by a de-aggregator. In one example, the constituent signals are the plurality of outbound signals. In one example, recover a time stamp from the aggregated signal. In one example, derive a calibrated time stamp by combining the recovered time stamp with a time offset. In one example, the time offset is derived from a time delay calibration. In one example, the main processor disclosed in FIG. 10 is an application processor.

In one aspect, one or more of the steps for providing bidirectional high-speed interfaces in FIG. 10 may be executed by one or more processors which may include hardware, software, firmware, etc. The one or more processors, for example, may be used to execute software or firmware needed to perform the steps in the flow diagram of FIG. 10. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising
an aggregator configured to aggregate a plurality of signals to form an aggregated signal;
a common transmission path coupled to the aggregator, the common transmission path configured to transport the aggregated signal, wherein the common transmission path includes a mechanical discontinuity; and
a deaggregator coupled to the common transmission path, the deaggregator configured to decompose the aggregated signal into one or more constituent signals.

2. The apparatus of claim 1, further comprising a processor coupled to the aggregator.

3. The apparatus of claim 2, wherein the aggregator is further configured to receive a plurality of signals in proximity to the processor.

4. The apparatus of claim 3, wherein the plurality of signals originates from a plurality of peripheral devices.

5. The apparatus of claim 4, wherein the plurality of peripheral devices includes one or more of the following: a camera, a display processor unit (DPU), an audio device, a serial engine (SE) information, or a first general purpose input output (GPIO) interface.

6. The apparatus of claim 3, wherein the one or more constituent signals is the plurality of signals.

7. The apparatus of claim 2, wherein the aggregated signal includes a time stamp.

8. The apparatus of claim 7, wherein the time stamp is a numeric representation of a local time at the processor.

9. The apparatus of claim 8, wherein the numeric representation of local time includes a specified time accuracy and a specified time stability.

10. The apparatus of claim 2, wherein the aggregated signal includes a plurality of incremental time stamps for each of the plurality of signals.

11. A method comprising:
aggregating a first plurality of signals to form an aggregated signal;
transporting the aggregated signal over a common transmission path, wherein the common transmission path includes a mechanical discontinuity; and
decomposing the aggregated signal into one or more constituent signals.

12. The method of claim 11, wherein the first plurality of signals originates from a plurality of peripheral devices.

13. The method of claim 11, further comprising using a packet aggregation protocol for aggregating the first plurality of signals.

14. The method of claim 13, wherein the packet aggregation protocol is performed asynchronously.

15. The method of claim 13, wherein the packet aggregation protocol is performed synchronously.

16. The method of claim 11, wherein the aggregated signal includes a time stamp.

17. The method of claim 16, wherein the time stamp is a numeric representation of a local time at a processor.

18. The method of claim 11, further comprising receiving the aggregated signal from the common transmission path in proximity to a first processor.

19. The method of claim 18, further comprising receiving one or more control signals from the common transmission path.

20. The method of claim 18, further comprising receiving the first plurality of signals in proximity to a second processor.

21. The method of claim 20, further comprising sending the one or more constituent signals to a plurality of output devices.

22. The method of claim 21, wherein the one or more constituent signals is the first plurality of signals.

23. The method of claim 12, further comprising sending a second plurality of signals from the first processor over the common transmission path.

24. The method of claim 23, further comprising receiving the second plurality of signals at a second processor and relaying the second plurality of signals to the plurality of peripheral devices.

25. An apparatus for bidirectional high-speed interfaces, the apparatus comprising:
means for aggregating a plurality of signals to form an aggregated signal;
means for transporting the aggregated signal over a common transmission path, wherein the common transmission path includes a mechanical discontinuity; and
means for decomposing the aggregated signal into one or more constituent signals.

26. The apparatus of claim 25, further comprising:
means for receiving the aggregated signal from the common transmission path in proximity to a first processor;
means for receiving the plurality of signals in proximity to a second processor; and
means for sending the one or more constituent signals to a plurality of output devices.

27. The apparatus of claim 26, wherein the aggregated signal includes a time stamp and wherein the time stamp is a numeric representation of a local time at the second processor, and the numeric representation of local time includes a specified time accuracy and a specified time stability.

28. The apparatus of claim 26, wherein the aggregated signal includes a plurality of incremental time stamps for each of the plurality of signals.

29. A non-transitory computer-readable medium storing computer executable code, operable on a device comprising at least one processor and at least one memory coupled to the at least one processor, wherein the at least one processor is configured to implement bidirectional high-speed interfaces, the computer executable code comprising:
instructions for causing a computer to aggregate a plurality of signals to form an aggregated signal;
instructions for causing the computer to transport the aggregated signal over a common transmission path, wherein the common transmission path includes a mechanical discontinuity; and
instructions for causing the computer to decompose the aggregated signal into one or more constituent signals.

30. The non-transitory computer-readable medium of claim 29, further comprising:
instructions for causing the computer to receive the aggregated signal from the common transmission path in proximity to a first processor;
instructions for causing the computer to receive the plurality of signals in proximity to a second processor, wherein the aggregated signal includes a time stamp and wherein the time stamp is a numeric representation of a local time at the second processor, and the numeric representation of local time includes a specified time accuracy and a specified time stability; and
instructions for causing the computer to send the one or more constituent signals to a plurality of output devices.
